(19) United States
(12) Patent Application Publication
(10) Pub. No.: US 2024/0054659 A1
(43) Pub. Date: Feb. 15, 2024

(54) OBJECT DETECTION IN DYNAMIC LIGHTING CONDITIONS

(71) Applicant: QUALCOMM Incorporated, San Diego, CA (US)

(72) Inventors: Louis Joseph KEROFSKY, San Diego, CA (US); Shihao SHEN, San Jose, CA (US)

(21) Appl. No.: 18/358,800

(22) Filed: Jul. 25, 2023

Related U.S. Application Data
(60) Provisional application No. 63/371,122, filed on Aug. 11, 2022.

(51) Int. Cl. G06T 7/246; G06T 5/00

(52) U.S. Cl. CPC G06T 7/248; G06T 5/002; G06T 2207/20081; G06T 2207/10152; G06T 2207/20084

(57) ABSTRACT

Disclosed are systems, apparatuses, processes, and computer-readable media to detect objects in dynamic lighting conditions. A method of processing image data includes obtaining, at a computing device, a first image of an object at a first position in an environment, obtaining, at the computing device, a second image of the object at a second position in the environment, and determining, at the computing device, movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, or brightness variations. The object and/or the computing device may move between the first image and the second image.

### PRIORITY CLAIM

This application claims the benefit of U.S. Provisional Application No. 63/371,122, filed on Aug. 11, 2022, which is hereby incorporated by reference, in its entirety and for all purposes.

### FIELD

In some examples, systems and techniques are described for detecting objects in dynamic lighting conditions.

### BACKGROUND

Multimedia systems are widely deployed to provide various types of multimedia communication content such as voice, video, packet data, messaging, broadcast, and so on. These multimedia systems may be capable of processing, storage, generation, manipulation, and rendition of multimedia information. Examples of multimedia systems include mobile devices, game devices, entertainment systems, information systems, virtual reality systems, model and simulation systems, and so on. These systems may employ a combination of hardware and software technologies to support the processing, storage, generation, manipulation, and rendition of multimedia information, for example, client devices, capture devices, storage devices, communication networks, computer systems, and display devices.

### SUMMARY

In some examples, systems and techniques are described for object detection. For example, the systems and techniques can be used for detecting objects in dynamic lighting environments. According to at least one example, a method is provided for detecting objects in dynamic lighting. The method includes: obtaining a first image of an object at a first position in an environment; obtaining a second image of the object at a second position in the environment; and determining movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, or brightness variations.

In another example, an apparatus for detecting objects in dynamic lighting is provided that includes at least one memory and at least one processor coupled to the at least one memory. The at least one processor is configured to: obtain a first image of an object at a first position in an environment; obtain a second image of the object at a second position in the environment; and determine movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, or brightness variations.

In another example, a non-transitory computer-readable medium is provided that has stored thereon instructions that, when executed by one or more processors, cause the one or more processors to: obtain a first image of an object at a first position in an environment; obtain a second image of the object at a second position in the environment; and determine movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, or brightness variations.

In another example, an apparatus for detecting objects in dynamic lighting is provided. The apparatus includes: means for obtaining a first image of an object at a first position in an environment; means for obtaining a second image of the object at a second position in the environment; and means for determining movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, or brightness variations.

In some aspects, one or more of the apparatuses described herein is, is part of, and/or includes a wearable device, an extended reality (XR) device (e.g., a virtual reality (VR) device, an augmented reality (AR) device, or a mixed reality (MR) device), a head-mounted device (HMD) device, a wireless communication device, a mobile device (e.g., a mobile telephone and/or mobile handset and/or so-called “smartphone” or another mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A, FIG. 1B, and FIG. 1C are diagrams illustrating example configurations for an image sensor of an image capture device, in accordance with aspects of the present disclosure.

FIG. 2 is a block diagram illustrating an architecture of an image capture and processing device, in accordance with aspects of the present disclosure.

FIG. 3 is a block diagram illustrating an example of an image capture system, in accordance with aspects of the present disclosure.

FIG. 4 is a diagram illustrating generation of a fused frame from short and long exposure frames, in accordance with aspects of the present disclosure.

FIG. 5 is a diagram illustrating long exposure and short exposure streams from an image sensor, in accordance with certain of the present disclosure.

FIG. 6A is an image with dynamic lighting conditions that can be used in an optical flow method.

FIG. 6B illustrates detection results of the image in FIG. 6A using an optical flow method in dynamic lighting conditions.

FIGS. 7A and 7B illustrate a pair of images with dynamic lighting conditions that can be used in an optical flow method in accordance with some aspects of the disclosure.

FIG. 8 illustrates an example of an image that is modified to improve noise robustness associated with dynamic lighting conditions in accordance with some aspects.

FIG. 9A illustrates an example of an image that is modified to improve motion robustness associated with dynamic lighting conditions in accordance with some aspects.

FIG. 9B depicts an example of various PSFs with different sizes and different intensities that can be applied to images to train an optical flow engine for motion blur robustness in accordance with some aspects of the disclosure.

FIG. 10 illustrates a method for training an optical flow engine for brightness variation robustness in accordance with some aspects of the disclosure.

FIG. 11A illustrates an example random mask that may be used to generate random variations for training an optical flow engine for brightness variation robustness in accordance with some aspects of the disclosure.

FIG. 11B illustrates a ground truth that may be used to generate a supervised loss for training an optical flow engine for brightness variation robustness in accordance with some aspects of the disclosure.

FIGS. 12A, 12B, 12C, and 12D are images that illustrate examples of optical flow based on training an optical flow for noise, motion, and brightness variation robustness in accordance with some aspects. FIG

FIG. 13 is a flowchart illustrating an example method for detecting objects with an optical flow engine in dynamic lighting conditions in accordance with aspects of the present disclosure.

FIG. 14 is an illustrative example of a deep learning neural network that can be used to implement the machine learning-based alignment prediction, in accordance with aspects of the present disclosure.

FIG. 15 is an illustrative example of a convolutional neural network (CNN), in accordance with aspects of the present disclosure.

FIG. 16 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor (ISP)) for processing the one or more image frames captured by the image sensor.

In some aspects, optical flow is used as a low-level component for many computer vision tasks. Optical flow provides an understanding of object movement in a scene (e.g., based on motion determined between two different frames or images). Optical flow can be applied for various applications, such as object tracking, video compression, image/frame interpolation, among others. For example, optical flow may be used for detection of moving objects between two different frames.

Optical flow techniques assume sufficient ambient lighting and static lighting conditions. Optical flow techniques generally perform poorly in low-light conditions and in dynamic lighting conditions (e.g., when lighting changes over time, such due to shadows, in shaded and/or covered areas such as in a tunnel or overpass, at night, etc.). For example, a vehicle approaching a crosswalk may be using sensors to observe a scene in front of the vehicle. However, the vehicle may be unable to identify a person crossing the crosswalk at night due to dark lighting conditions.

The performance of optical flow methods is poor in low-lighting conditions and dynamic lighting conditions due to various issues. For example, noise associated with a darker image can result in a lower signal-to-noise ratio (SNR) image. In another example, using a long exposure when capturing an image in low-light conditions can result in a blurred image. In another example, optical flow engines may assume a constant brightness and static lighting conditions when performing optical flow. However, varying illumination in a scene violates the brightness consistency assumption. For instance, computer vision (CV) tasks (e.g., performed by autonomous or semi-autonomous vehicles, extended reality (XR) devices, robotics devices, etc.) may need to operate in dynamic lighting conditions where lighting conditions are changing (e.g., due to shadows, at night, in shaded and/or covered areas, etc.). CV tasks may misidentify or fail to detect objects when lighting is poor. Techniques are needed for providing improved optical flow operations under a range of lighting conditions.

In some aspects, systems, apparatuses, processes (also referred to as methods), and computer-readable media (collectively referred to herein as “systems and techniques”) are described for generating detecting objects in dynamic lighting conditions. For instance, a computing device can obtain a first image of an object at a first position in an environment and can obtain a second image of the object at a second position in the environment that is different from the first position. After obtaining the first image and the second image, the computing device can determine movement of the object in the first image and the second image at least in part using an optical flow engine. In some aspects, the optical flow engine is trained based on augmented training data. For example, the augmented training data can be generated using noise associated with low ambient lighting conditions, noise associated with motion blur due to exposure of an image sensor in low ambient lighting conditions, spatial or temporal illumination variations, any combination thereof, and/or other information.

In some aspects, the systems and techniques can improve optical flow operation in many different lighting conditions and can improve CV tasks (e.g., CV detection tasks). In some cases, the systems and techniques can reduce the need for additional sensors, resulting in additional sensors becoming unnecessary (e.g., based on improved detection in different conditions) and reducing hardware cost.

In some cases, the description herein provide examples of a computing device (e.g., a CV device) as a vehicle (e.g., an autonomous or semi-autonomous vehicle) for illustrative purposes. However, a computing device configured to perform the systems and techniques described herein can include any type of device, such as XR devices, robotics devices (e.g., manufacturing robots, cleaning robots, automated warehouse robots, surgical robots, exploratory robots, etc.), mobile devices, among others.

Various aspects of the techniques described herein will be discussed below with respect to the figures.

Image sensors include one or more arrays of photodiodes or other photosensitive elements. Each photodiode measures an amount of light that eventually corresponds to a particular pixel in the image produced by the image sensor. In some cases, different photodiodes may be covered by different color filters of a color filter array and may thus measure light matching the color of the color filter covering the photodiode.

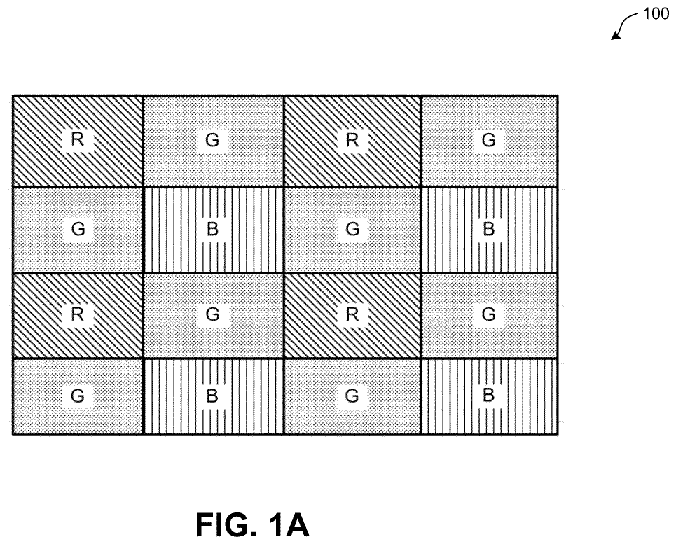

Various color filter arrays can be used, including a Bayer color filter array, a quad color filter array (also referred to as a quad Bayer filter or QCFA), and/or other color filter array. An example of a Bayer color filter array 100 is shown in FIG. 1A. As shown, the Bayer color filter array 100 includes a repeating pattern of red color filters, blue color filters, and green color filters. As shown in FIG. 1B, a QCFA 110 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the QCFA 110 shown in FIG. 1B is repeated for the entire array of photodiodes of a given image sensor. Using either QCFA 110 or the Bayer color filter array 100, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. The different photodiodes throughout the pixel array can have different spectral sensitivity curves, therefore responding to different wavelengths of light. Monochrome image sensors may also lack color filters and therefore lack color depth.

In some cases, subgroups of multiple adjacent photodiodes (e.g., 2×2 patches of photodiodes when QCFA 110 shown in FIG. 1B is used) can measure the same color of light for approximately the same region of a scene. For example, when photodiodes included in each of the subgroups of photodiodes are in close physical proximity, the light incident on each photodiode of a subgroup can originate from approximately the same location in a scene (e.g., a portion of a leaf on a tree, a small section of sky, etc.).

In some examples, a brightness range of light from a scene may significantly exceed the brightness levels that the image sensor can capture. For example, a digital single-lens reflex (DSLR) camera may be able to capture a 1:30,000 contrast ratio of light from a scene while the brightness levels of an HDR scene can exceed a 1:1,000,000 contrast ratio.

In some cases, high-dynamic range (HDR) sensors may be utilized to enhance the contrast ratio of an image captured by an image capture device. In some examples, HDR sensors may be used to obtain multiple exposures within one image or frame, where such multiple exposures can include short (e.g., 5 ms) and long (e.g., 15 or more ms) exposure times. As used herein, a long exposure time generally refers to any exposure time that longer than a short exposure time.

In some implementations, HDR sensors may be able to configure individual photodiodes within subgroups of photodiodes (e.g., the four individual R photodiodes, the four individual B photodiodes, and the four individual G photodiodes from each of the two 2×2 G patches in the QCFA 110 shown in FIG. 1B) to have different exposure settings. A collection of photodiodes with matching exposure settings is also referred to as photodiode exposure group herein. FIG. 1C illustrates a portion of an image sensor array with a QCFA filter that is configured with four different photodiode exposure groups 1 through 4. As shown in the example photodiode exposure group array 120 in FIG. 1C, each 2×2 patch can include a photodiode from each of the different photodiode exposure groups for a particular image sensor. Although four groupings are shown in a specific grouping in FIG. 1C, a person of ordinary skill will recognize that different numbers of photodiode exposure groups, different arrangements of photodiode exposure groups within subgroups, and any combination thereof can be used without departing from the scope of the present disclosure.

As noted with respect to FIG. 1C, in some HDR image sensor implementations, exposure settings corresponding to different photodiode exposure groups can include different exposure times (also referred to as exposure lengths), such as short exposure, medium exposure, and long exposure. In some cases, different images of a scene associated with different exposure settings can be formed from the light captured by the photodiodes of each photodiode exposure group. For example, a first image can be formed from the light captured by photodiodes of photodiode exposure group 1, a second image can be formed from the photodiodes of photodiode exposure group 2, a third image can be formed from the light captured by photodiodes of photodiode exposure group 3, and a fourth image can be formed from the light captured by photodiodes of photodiode exposure group 4. Based on the differences in the exposure settings corresponding to each group, the brightness of objects in the scene captured by the image sensor can differ in each image. For example, well-illuminated objects captured by a photodiode with a long exposure setting may appear saturated (e.g., completely white). In some cases, an image processor can select between pixels of the images corresponding to different exposure settings to form a combined image.

In one illustrative example, the first image corresponds to a short exposure time (also referred to as a short exposure image), the second image corresponds to a medium exposure time (also referred to as a medium exposure image), and the third and fourth images correspond to a long exposure time (also referred to as long exposure images). In such an example, pixels of the combined image corresponding to portions of a scene that have low illumination (e.g., portions of a scene that are in a shadow) can be selected from a long exposure image (e.g., the third image or the fourth image). Similarly, pixels of the combined image corresponding to portions of a scene that have high illumination (e.g., portions of a scene that are in direct sunlight) can be selected from a short exposure image (e.g., the first image.

In some cases, an image sensor can also utilize photodiode exposure groups to capture objects in motion without blur. The length of the exposure time of a photodiode group can correspond to the distance that an object in a scene moves during the exposure time. If light from an object in motion is captured by photodiodes corresponding to multiple image pixels during the exposure time, the object in motion can appear to blur across the multiple image pixels (also referred to as motion blur). In some implementations, motion blur can be reduced by configuring one or more photodiode groups with short exposure times. In some implementations, an image capture device (e.g., a camera) can determine local amounts of motion (e.g., motion gradients) within a scene by comparing the locations of objects between two consecutively captured images. For example, motion can be detected in preview images captured by the image capture device to provide a preview function to a user on a display. In some cases, a machine learning model can be trained to detect localized motion between consecutive images.

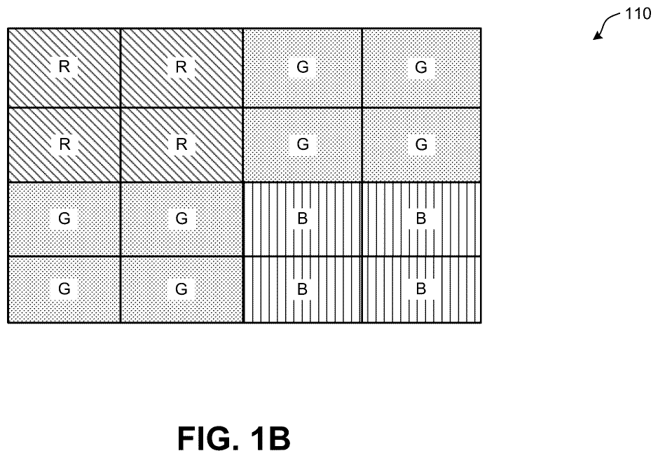

FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. In some cases, the lens 215 and image sensor 230 can be associated with an optical axis. In one illustrative example, the photosensitive area of the image sensor 230 (e.g., the photodiodes) and the lens 215 can both be centered on the optical axis. A lens 215 of the image capture and processing system 200 faces a scene 210 and receives light from the scene 210. The lens 215 bends incoming light from the scene toward the image sensor 230. The light received by the lens 215 passes through an aperture. In some cases, the aperture (e.g., the aperture size) is controlled by one or more control mechanisms 220 and is received by an image sensor 230. In some cases, the aperture can have a fixed size.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo (or other lens mechanism), thereby adjusting focus. In some cases, additional lenses may be included in the image capture and processing system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 220, the image sensor 230, and/or the image processor 250. The focus setting may be referred to as an image capture setting and/or an image processing setting. In some cases, the lens 215 can be fixed relative to the image sensor and focus control mechanism 225B can be omitted without departing from the scope of the present disclosure.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 225C moves one or more of the lenses in the afocal zoom system, such as the negative lens and one or both of the positive lenses. In some cases, zoom control mechanism 225C can control the zoom by capturing an image from an image sensor of a plurality of image sensors (e.g., including image sensor 230) with a zoom corresponding to the zoom setting. For example, image processing system 200 can include a wide angle image sensor with a relatively low zoom and a telephoto image sensor with a greater zoom. In some cases, based on the selected zoom setting, the zoom control mechanism 225C can capture images from a corresponding sensor.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different filters. In some cases, different photodiodes can be covered in color filters, and may thus measure light matching the color of the filter covering the photodiode. Various color filter arrays can be used, including a Bayer color filter array (as shown in FIG. 1A), a QCFA (see FIG. 1B), and/or any other color filter array.

Returning to FIG. 1A and FIG. 1B, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 230) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 230 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, an ultraviolet (UV) cut filter, a band-pass filter, low-pass filter, high-pass filter, or the like). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

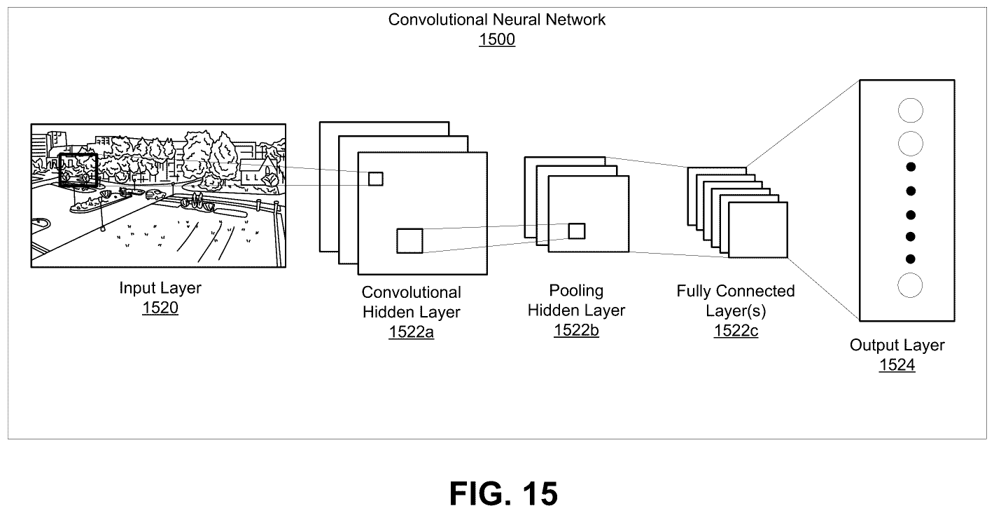

The image processor 250 may include one or more processors, such as one or more ISPs (e.g., ISP 254), one or more host processors (e.g., host processor 252), and/or one or more of any other type of processor 1610 discussed with respect to the computing system 1600 of FIG. 15. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240, read-only memory (ROM) 245, a cache, a memory unit, another storage device, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 1635, any other input devices 1645, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the image capture and processing system 200 and one or more peripheral devices, over which the image capture and processing system 200 may receive data from the one or more peripheral device and/or transmit data to the one or more peripheral devices. The I/O 260 may include one or more wireless transceivers that enable a wireless connection between the image capture and processing system 200 and one or more peripheral devices, over which the image capture and processing system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

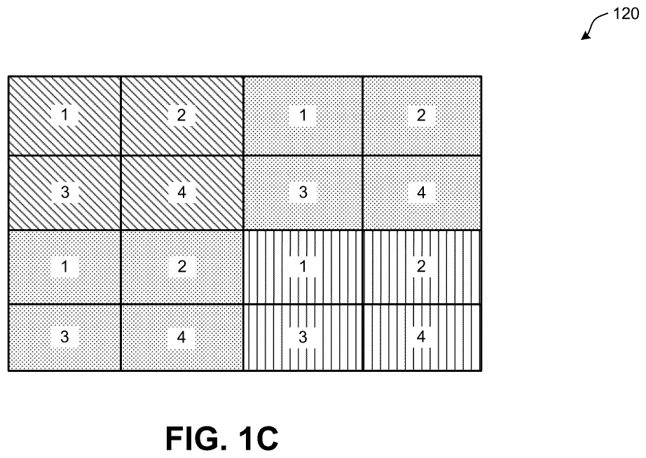

FIG. 3 is a block diagram illustrating an example of an image capture system 300. The image capture system 300 includes various components that are used to process input images or frames to produce an output image or frame. As shown, the components of the image capture system 300 include one or more image capture devices 302, an image processing engine 310, and an output device 312. The image processing engine 310 can produce high dynamic range depictions of a scene, as described in more detail herein.

The image capture system 300 can include or be part of an electronic device or system. For example, the image capture system 300 can include or be part of an electronic device or system, such as a mobile or stationary telephone handset (e.g., smartphone, cellular telephone, or the like), an extended reality (XR) device (e.g., a virtual reality (VR) device, an augmented reality (AR) device, or a mixed reality (MR) device), a vehicle or computing device/system of a vehicle, a server computer (e.g., in communication with another device or system, such as a mobile device, an XR system/device, a vehicle computing system/device, etc.), a desktop computer, a laptop or notebook computer, a tablet computer, a set-top box, a television, a camera device, a display device, a digital media player, a video streaming device, or any other suitable electronic device. In some examples, the image capture system 300 can include one or more wireless transceivers (or separate wireless receivers and transmitters) for wireless communications, such as cellular network communications, 802.11 Wi-Fi communications, WLAN communications, Bluetooth or other short-range communications, any combination thereof, and/or other communications. In some implementations, the components of the image capture system 300 can be part of the same computing device. In some implementations, the components of the image capture system 300 can be part of two or more separate computing devices.

While the image capture system 300 is shown to include certain components, one of ordinary skill will appreciate that image capture system 300 can include more components or fewer components than those shown in FIG. 3. In some cases, additional components of the image capture system 300 can include software, hardware, or one or more combinations of software and hardware. For example, in some cases, the image capture system 300 can include one or more other sensors (e.g., one or more inertial measurement units (IMUs), radars, light detection and ranging (LIDAR) sensors, audio sensors, etc.), one or more display devices, one or more other processing engines, one or more other hardware components, and/or one or more other software and/or hardware components that are not shown in FIG. 3. In some implementations, additional components of the image capture system 300 can include and/or can be implemented using electronic circuits or other electronic hardware, which can include one or more programmable electronic circuits (e.g., DSPs, microprocessors, microcontrollers, GPUs, CPUs, any combination thereof, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture system 300.

The one or more image capture devices 302 can capture image data and generate images (or frames) based on the image data and/or can provide the image data to the image processing engine 310 for further processing. The one or more image capture devices 302 can also provide the image data to the output device 312 for output (e.g., on a display). In some cases, the output device 312 can also include storage. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image. In addition to image data, the image capture devices can also generate supplemental information such as the amount of time between successively captured images, timestamps of image capture, or the like.

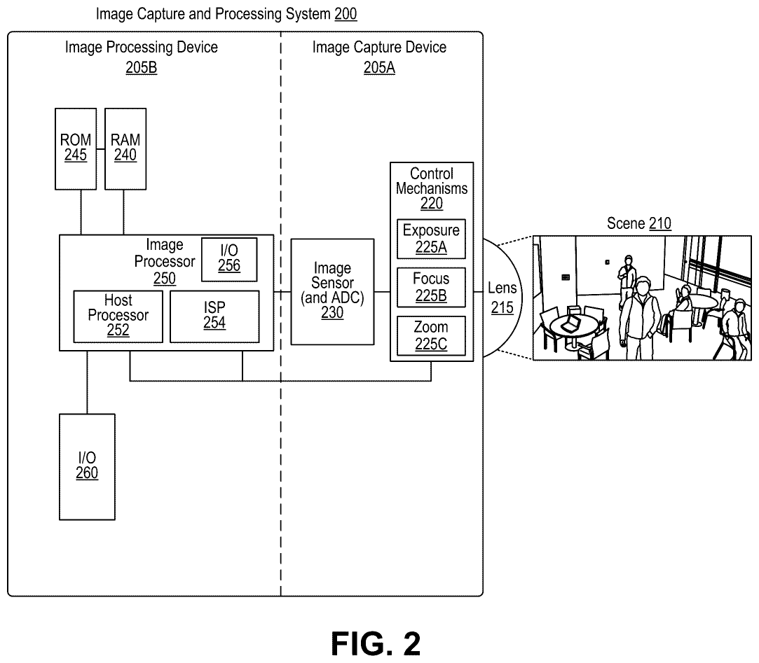

FIG. 4 illustrates techniques for generating a fused frame from short and long exposure frames. As shown, a short exposure frame 402 and a long exposure frame 404 may be taken, which may be fused to provide a fused frame output 406 (e.g., an HDR frame output). Due to a bit depth of an image capture sensor, some pixels of a capture frame may be oversaturated, resulting in the image not showing some textures of a scene as shown in the short exposure frame 402. Thus, to generate an HDR frame, both short and long exposure frames may be captured, which may be fused (e.g., combined) to generate an HDR output frame. A fusion of short and long exposure frames may be performed to generate a fused output frame that includes parts of the short exposure frame and parts of the long exposure frame. For example, region 408 of the fused frame output 406 may be from the long exposure frame 404, while region 410 of the fused frame output 406 may be from the short exposure frame 402. However, fusing short and long exposure frames may result in irregularities due to global motion (e.g., motion of the image capture device). For example, from the time when the long exposure frame is captured to the time when the short-exposure frame is captured, the image capture device or objects in a scene may have moved, causing irregularities if steps are not taken to align the short and long exposure frames prior to fusing the frames together. This global motion issue may also arise due to a rolling shutter, as described in more detail herein.

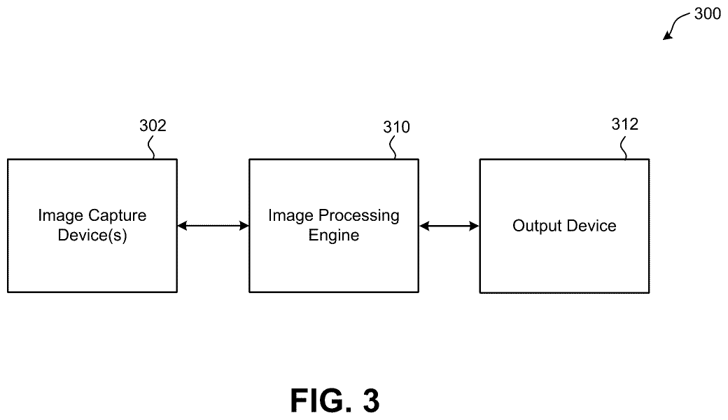

FIG. 5 is a diagram illustrating long exposure and short exposure streams (e.g., MIPI stream) from an image sensor (e.g., image sensor 230) to an imaging front end for processing. Line 502 represents the start of long exposure sensing (also referred to herein as normal exposure sensing), and line 504 represents the end of the long exposure sensing. The long exposure sensing starts from the first row of a sensor (e.g., image sensor 230 of FIG. 2) to the last row of the sensor, as shown. For each row (e.g., row of photodiodes), once the long exposure sensing has completed, short exposure sensing begins while the long exposure sensing continues to the next row. For example, line 506 represents the beginning of the short exposure sensing, and line 508 represents the end of the short exposure sensing, starting from the first row to the last row of the image sensor. The long exposure sensing (e.g., having a duration labeled “N Normal” in FIG. 5) may begin prior to the short exposure sensing (e.g., having a duration labeled “N short” in FIG. 5).

Once the long exposure sensing for a particular row is completed, a short delay (e.g., associated with the gap between lines 504, 506) occurs before the short exposure sensing begins. Once the short exposure sensing has finished for a particular row, the information for the row is read out from the image sensor for processing. Due to the gap from the long exposure sensing to the short exposure sensing (e.g., shown as an average motion delay (D) in FIG. 5), an opportunity exists for a user who is holding the camera to move and/or for objects in a scene being captured to move, resulting in a misalignment of features in the short and long exposure frames (e.g., features that are common or the same in the short and long exposure frames). For example, a motion delay (D) may exist from time 550 (e.g., time when half of the long exposure data is captured) and time 552 (e.g., the time when half of the short exposure data is captured). The motion delay (D) may be estimated as being the average motion delay associated with different long and short frame capture events (e.g., different HDR frame captures).

Because the sensing occurs one row at a time (e.g., starting from the first row to the last row), a rolling shutter global motion also occurs. The camera or objects in scene may move from when the data for a first row of sensors are captured to when the data for a last row of sensors are captured.

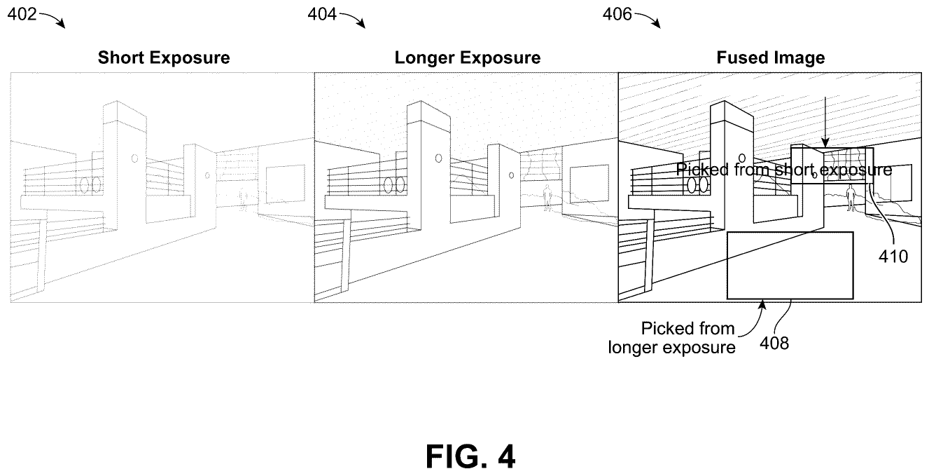

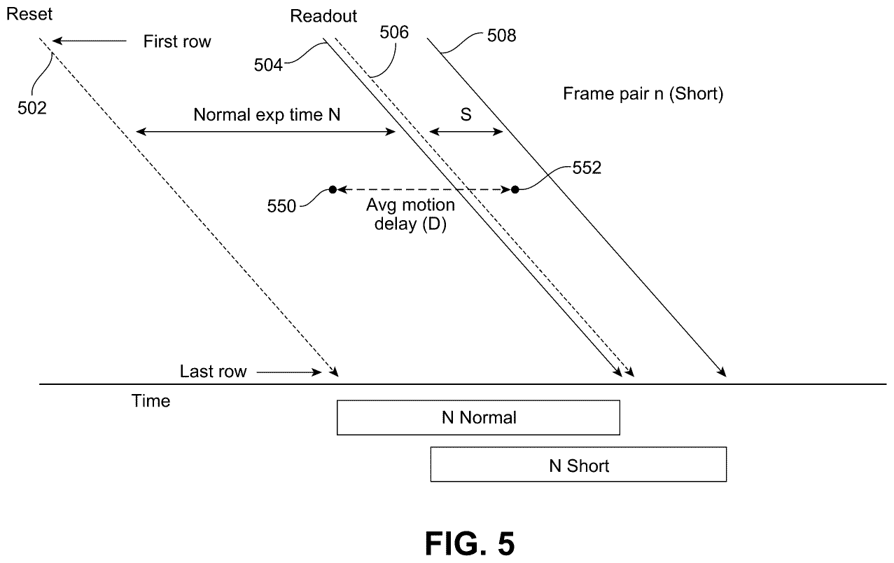

As noted previously, optical flow techniques may assume sufficient ambient lighting and static lighting conditions, and thus may perform poorly in low-light conditions and in dynamic lighting conditions. FIG. 6A is an image captured in low-light and dynamic lighting conditions that can be used in an optical flow method. In some aspects, a computing device (e.g., a computing device of an autonomous vehicle (AV), a mobile device, an XR device such as a virtual reality (VR) or augmented reality (AR) headset, etc.) may implement an object detection engine that is configured to perform optical flow estimation using an optical flow engine to determine missing objects in low or variable lighting. In some cases, the object detection engine may be a machine learning based object detection engine, such as a service-oriented architecture (SOA) Recurrent All-Pairs Field Transforms (RAFT) neural network. The optical flow engine may use a pair of images (or frames) to detect the motion of objects between the two images. As shown in FIG. 6A, a pedestrian 602 is traversing a scene during dynamic lighting conditions based on low ambient light conditions (e.g., at night where low-light conditions are present) in front of a car with headlights.

FIG. 6B illustrates an example of detection results based on the object detection engine (e.g., implemented as an SOA RAFT neural network) applying object detection to the image in FIG. 6A using the optical flow engine in the dynamic lighting conditions. In particular, FIG. 6B illustrates a pseudocolor representation of two-dimensional (2D) motion vectors associated with the object. The white color indicates no motion, the specific color indicating the direction of the motion vectors, and an intensity of the color corresponding to velocity. However, as illustrated in FIG. 6B, the pedestrian 602 is not detected due to the dynamic lighting conditions.

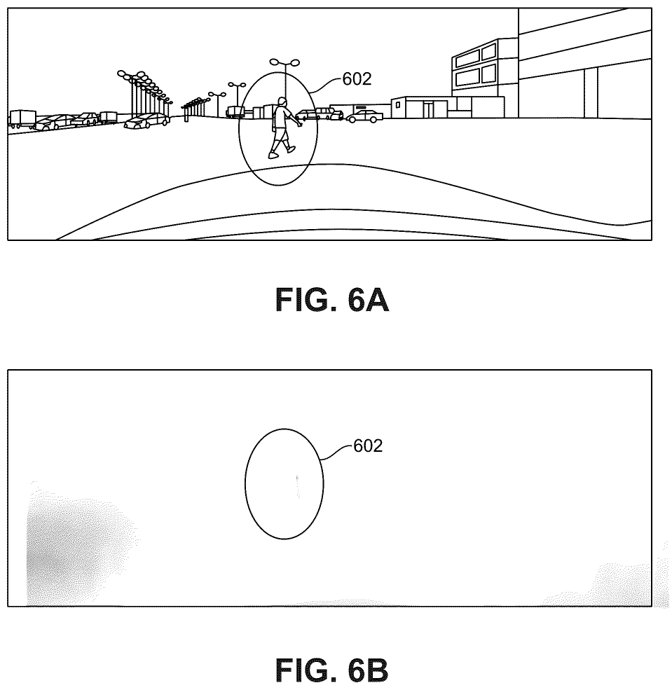

FIGS. 7A and 7B illustrate a pair of images captured in dynamic lighting conditions that can be used in an optical flow method in accordance with some aspects of the disclosure. In the example of FIGS. 7A and 7B, a camera system is mounted to a vehicle. The vehicle is driving at night when lighting conditions are dynamically changing due to low ambient lighting conditions and the presence of several light sources, such as vehicles traveling in the same direction, vehicles traveling in the opposite direction, lighting from buildings, lighting from streetlights, etc. The optical flow method may be configured to detect motion of objects within the environment, as well as the motion of the vehicle in some cases. For example, the vehicle may use the optical flow method to identify a speed of an oncoming vehicle with respect to the vehicle or to identify a speed differential based on another vehicle in front of the vehicle and the speed of the vehicle.

FIGS. 7A and 7B illustrate two example images, including image 702 and image 704, that can be used in an optical flow method to detect object movement based on differences between the two images. Two example images 702, 704 illustrated in FIGS. 7A and 7B will be referred to as an image pair. As will be described below, an image pair may be modified to train an optical flow engine in dynamic lighting conditions. For example, the image pair can be modified to add noise robustness, motion blur robustness, and brightness variation robustness.

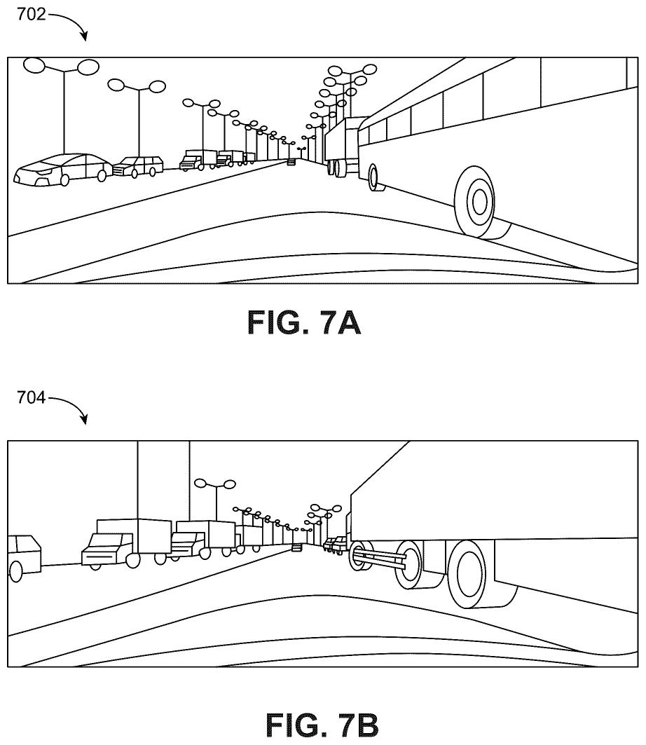

FIG. 8 illustrates an example of an image 802 (e.g., of an image pair) that is modified to improve noise robustness associated with dynamic lighting conditions in accordance with some aspects. In particular, the image 702 in FIG. 7A is augmented with noise to produce the image 802 illustrated in FIG. 8. In some aspects, image pairs can be modified to introduce noise that is associated with images in low-light conditions. In some cases, the noise includes spatial Gaussian noise that emulates capturing of images in low-light conditions. In some examples, the noise applied to the image pair can be the same or different per image.

In some cases, modifying the image 702 of FIG. 7A to produce the image 802 of FIG. 8 can include randomly inverting the gamma correction of RGB channels to mimic the uncorrected light effects and white balance. For example, the noise at night can be approximated as a combination of Poisson and Gaussian distributions to mimic photon shot noise and thermal readout noise of an image sensor in low-light image conditions. One example of a method includes sampling Poisson and Gaussian parameters from ranges observed in real-world low-light imagery. The image, I, can be represented as I(x)=N(μ=x, σ²=ax+b), where I is an image, x is a pixel of the image, μ a mean value, σ is the variation, N is a normal distribution, and the a and b variables are different and correspond to one of the first random noise or the second random noise. In this case, addition of the noise produces the modified image 802 as a single heteroscedastic Gaussian distribution as illustrated in FIG. 8.

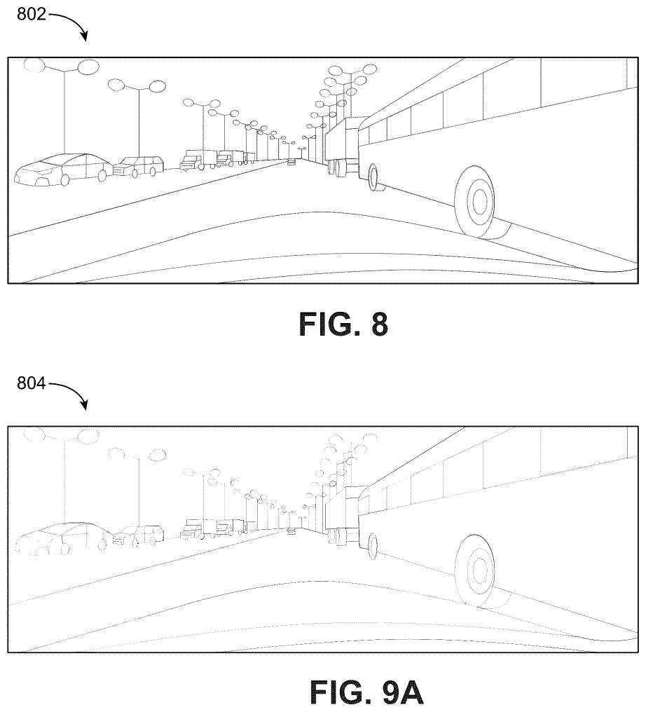

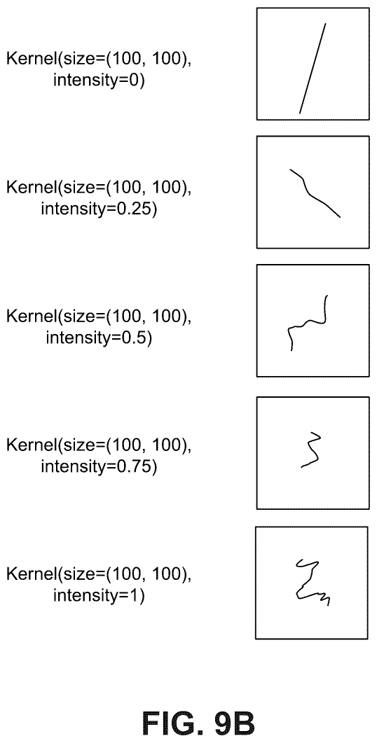

FIG. 9A illustrates an example of an image that is modified to improve motion robustness associated with dynamic lighting conditions in accordance with some aspects. As noted above, longer exposure times in low ambient conditions create a motion blur and images may be modified based on the noise to train the optical flow engine for motion blur. In one illustrative aspect, a method can generate motion blur using Point Spread Functions (PSF) at different kernel sizes and intensities. For example, an intensity of a PSF can determine how non-linear and shaken the motion blur is.

FIG. 9B depicts an example of various PSFs with different kernel sizes and different intensities that can be applied to images to train an optical flow engine for motion blur robustness in accordance with some aspects of the disclosure. In some aspects, the data augmentation (either noise robustness or motion robustness) may be applied to training data to create a separate training data set or may be selected during training. For example, the training system can determine an average intensity (e.g. luma) and select images based on average luma, or distribution of the luma.

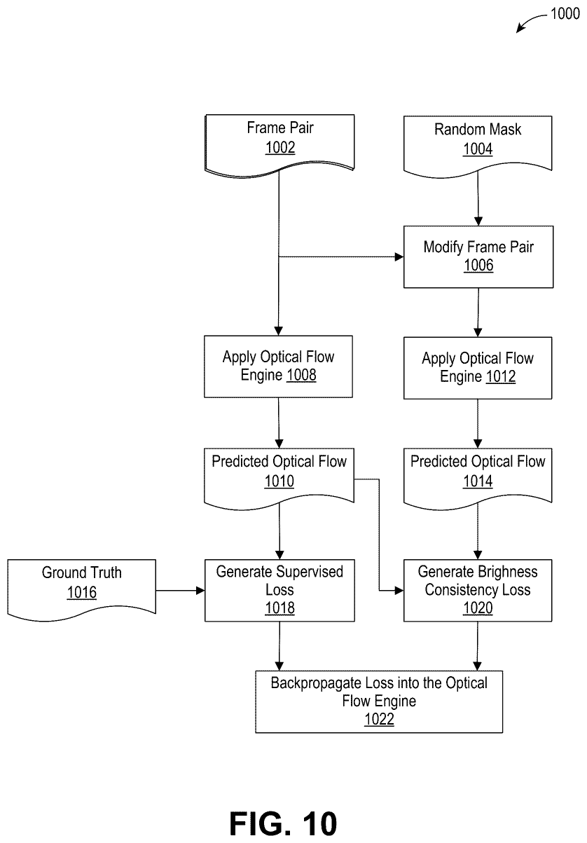

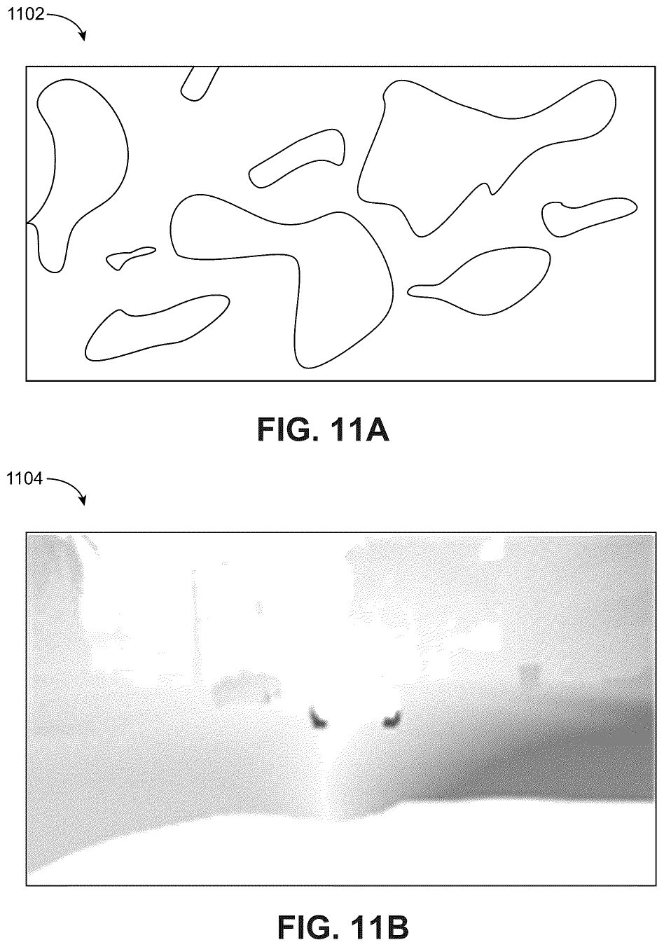

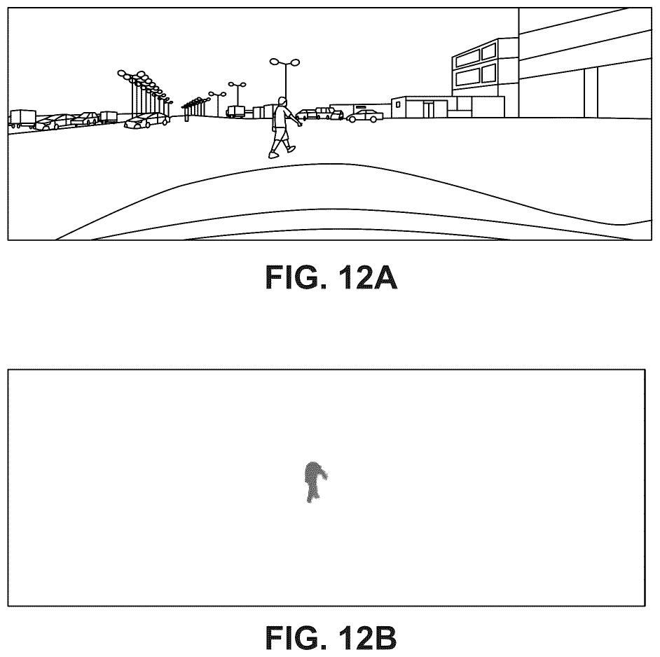

FIG. 10 illustrates a method 1000 for training an optical flow engine for brightness variation robustness in accordance with some aspects of the disclosure. In some aspects, a system is configured to perform the method illustrated in FIG. 10 to train an optical flow engine, such as a RAFT neural network, for robustness due to dynamic lighting conditions. In some aspects, a frame pair 1002 is provided and a mask 1004 is generated. The mask 1004 can be referred to as a random mask. An example of a random mask is illustrated in FIG. 11A.

At block 1006, the frame pair 1002 is modified based on at least one random mask (e.g., the mask 1004). In one example, the brightness of the frame pair 1002 is changed based on a random mask (e.g., the mask 1004), such as increasing the brightness by 10%. In some cases, the same random mask is applied to each frame, or a different random mask is applied to each frame. In some cases, the random mask may be modified based on the first random mask (e.g., the random masks can be related based on a random transformation).

At block 1008, the unmodified frame pair 1002 is provided to an optical flow engine to detect motion to generate a predicted optical flow 1010. At block 1012, the modified frame pair is applied to the same optical flow engine to generate a predicted optical flow 1014. At block 1018, a ground truth 1016 (e.g., a ground truth optical flow map) is applied to the predicted optical flow 1010 to generate a supervised loss based on the ground truth 1016. An illustrative example of a ground truth 1016 is illustrated herein with reference to FIG. 11B. At block 1020, the training system calculates the loss between the predicted optical flow 1010 from the unmodified frame pair and the predicted optical flow 1014 from the modified frame pair to generate a brightness (or illumination) consistency loss. The brightness consistency loss identifies how much the brightness variation affected the optical flow engine in generating the optical flow output.

At block 1022, the supervised loss and the brightness consistency loss are used to perform backpropagation to tune parameters (e.g., weights, biases, etc.) of the optical flow engine. In one illustrative aspect, the supervised loss and the brightness consistency loss are summed and used for the backpropagation.

FIG. 11A illustrates an example random mask that may be used to generate random variations for training an optical flow engine for brightness variation robustness in accordance with some aspects of the disclosure. In some aspects, the black region illustrated in FIG. 11A remains unmodified and transparent regions of a training image are modified. For example, the regions of a training image corresponding to the transparent regions may be brightened. Other types of modification based on the mask may be introduced, such as modifying colors based on the mask, desaturating an image based on the mask, and so forth.

FIG. 11B illustrates a ground truth 1102 (e.g., a ground truth optical flow map) that may be used to generate a supervised loss for training an optical flow engine for brightness variation robustness in accordance with some aspects of the disclosure, such as using the techniques described in FIG. 10. In some aspects, the ground truth is validation data that is provided to the training system.

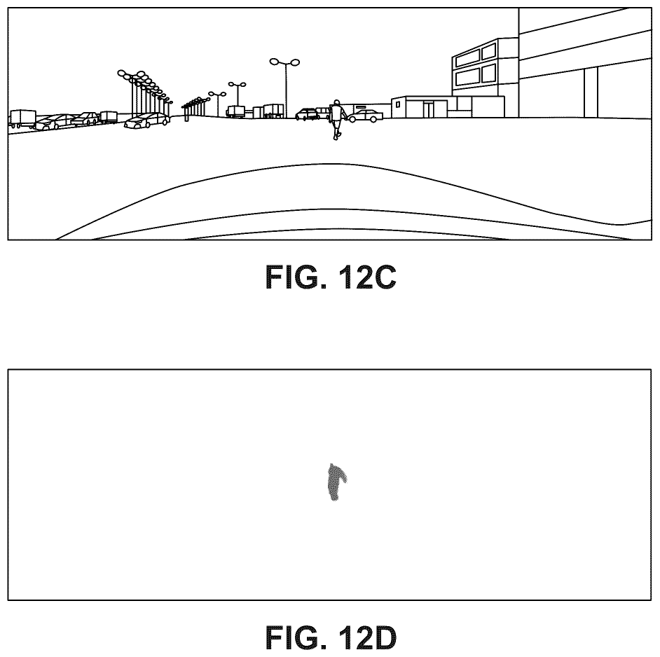

FIGS. 12A, 12B, 12C, and 12D are images that illustrate various aspects associated with optical flow based on training an optical flow engine for noise, motion, and brightness variation robustness in accordance with some aspects. FIG. 12A depicts the first scene with a pedestrian crossing a region that is enhanced by a light source, but the pedestrian is partially lightened. FIG. 12B illustrates a detection result using an optical flow engine that is trained for the various noise robustness, motion blur robustness, and brightness variation robustness. In particular, FIG. 12C is a pseudocolor representation of 2D motion vectors associated with the pedestrian, which illustrates a person is identified based on the motion, even though a part of the person is disposed within the ambient light and difficult to perceive, and the other part of the person is lighted by the external light source and can be easily perceived.

FIG. 12C illustrates another example of a scene of a pedestrian in a dynamic lighting condition and FIG. 12D is a pseudocolor representation of 2D motion vectors associated with the object and illustrates that the pedestrian is detected in the dynamic lighting conditions.

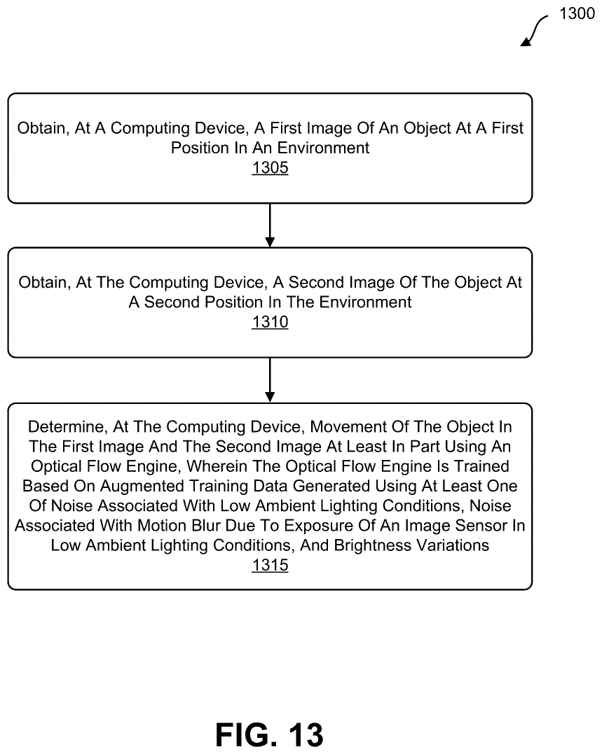

FIG. 13 is a flowchart illustrating an example method 1300 for detecting objects with an optical flow engine in dynamic lighting conditions in accordance with aspects of the present disclosure. The method 1300 can be performed by a computing device having an image sensor, such as a mobile wireless communication device, an AV, a CV robot function (e.g., manufacturing), a camera, an XR device, a wireless-enabled vehicle, or another computing device. In one illustrative example, a computing system 1600 can be configured to perform all or part of the method 1300. In one illustrative example, an ISP such as the ISP 254 can be configured to perform all or part of the method.

Although the example method 1300 depicts a particular sequence of operations, the sequence may be altered without departing from the scope of the present disclosure. For example, some of the operations depicted may be performed in parallel or in a different sequence that does not materially affect the function of the method 1300. In other examples, different components of an example device or system that implements the method 1300 may perform functions at substantially the same time or in a specific sequence.

According to some examples, at block 1305, the method 1300 includes obtaining (e.g., by a computing system 1600) a first image of an object at a first position in an environment. The environment comprises an outdoor environment that is being traversed by an apparatus that includes a control system for traversing the environment. A computing system is configured to control traversal of the environment based on at least one of movement of the object or movement of the apparatus.

According to some examples, at block 1310, the method 1300 includes obtaining (e.g., by a computing system 1600) a second image of the object at a second position in the environment. The second position may be different from the first position. A part of the object is illuminated in the first image and a different part of the object is illuminated in the second image. In one aspect, an object may be moving through the illuminated region and reflects light from low ambient lighting (e.g., a dark region) and another region may be illuminated by a light source. In some aspects, the image will contain an uneven distribution of dark content and light content. In some aspects, low ambient lighting may correspond to the absence of daylight, and bright regions correspond to the presence of daylight or proximate to light sources.

According to some examples, at block 1315, the method 1300 includes determining (e.g., by a computing system 1600) movement of the object in the first image and the second image at least in part using an optical flow engine. The optical flow engine is trained based on augmented training data generated using at least one of noise associated with low ambient lighting conditions, noise associated with motion blur due to exposure of an image sensor in low ambient lighting conditions, or brightness variations. In one illustrative example, the optical flow engine comprises a Recurrent All-Pairs Field Transforms (RAFT) neural network.

In some aspects, the optical flow engine is trained based on noise associated with low ambient lighting conditions. The method 1300 may include augmenting training data based on noise associated with the environment. The method 1300 may include generating the augmented training data using the noise associated with the low ambient lighting conditions and training the optical engine based on the augmented training data. In some cases, generating the augmented training data using the noise associated with the low ambient lighting conditions may include applying first noise (e.g., random noise) to a training image pair based on the ambient lighting. The noise associated with the environment corresponds to I(x)=N(μ=x, σ²=ax+b), where I is an image, x is a pixel of the image, μ a mean value, a is the variation, N is a normal distribution, and the a and b variables are different and correspond to one of the first noise or the second noise (e.g., random noise). Further, the method comprises applying second noise to the training image pair based on thermal conditions (e.g., a thermal noise). In some cases, as described previously, the first noise comprises a photon shot noise associated with the low ambient lighting conditions and the second noise comprises thermal readout noise associated with the image sensor.

In some cases, the method 1300 can include augmenting training data based on a noise associated with motion within the environment. For instance, the method 1300 can include generating the augmented training data using the noise associated with the motion blur and training the optical engine based on the augmented training data. In some examples, generating the augmented training data using the noise associated with the motion blur may include. In one example, the optical flow engine is trained by applying at least one motion blur kernel to a training image pair based on at least one parameter. For example, as illustrated in FIG. 9A, a computing system may apply a motion blur (e.g., a motion blur kernel) to a training image pair based on at least one parameter. In some aspects, the at least one parameter is associated with a PSF to emulate motion blur (e.g., which may correspond to a long exposure in the ambient lighting). In some cases, the at least one parameter includes a motion blur kernel size, an intensity, a linear direction, a non-linear direction, any combination thereof, and/or other parameter(s). In one example, the method 1300 may generate motion blur kernels using the PSF at different kernel sizes and intensities (e.g., where the intensity determines how non-linear and shaken the motion blur is).

In some cases, the method 1300 can include training of the optical flow engine based on brightness variation comprises modifying training data to reduce sensitivity to light variation. In some cases, the method 1300 can include generating the augmented training data using the brightness variations and training the optical engine based on the augmented training data. For example, a computing system 1600 can change a brightness of regions in a training image based on a mask (e.g., a random mask 1004, such as the mask) to yield a modified training image. In some aspects, generating the augmented training data using the brightness variations includes obtaining or generating a random mask, modifying a training image (e.g., modifying brightness of regions in the training image) based on the random mask (e.g., changing brightness) to generate a modified training image. The method 1300 may include estimating motion in the unmodified training image pair and the modified training image pair. The method 1300 may further include inputting the training image and the modified training image into a neural network, determine a first loss associated with the training image and an output of the neural network based on processing the training image, and determining a second loss associated with the modified training image input and an output of the neural network based on processing the modified training image. The method 1300 may then include training the neural network based on the first loss and the second loss.

Further, the method 1300 comprises summing the first loss and the second loss to generate a total loss. The neural network can then be trained based on the total loss (e.g., by backpropagating the total loss into the neural network). Training of the neural network (e.g., via the backpropagation) may desensitize the neural network to variations in brightness between the first image and the second image.

In some aspects, the method 1300 may include determining at least one of a direction or a velocity of the object based on output from the optical flow engine. The direction and velocity comprises one of a float value or a vector value.

In some aspects, optical flow detections under low-light conditions are affected based on a complex noise model at night, severe motion blur due to longer exposure time, and inconsistent local brightness brought by different independent light sources in the scene. The optical flow engine can be trained based on augmented training data and improves the model performance in the nighttime based on noise, motion blur, and random brightness variations. The optical flow engine can be trained based on the augmented training data and using a brightness variation and improve detection of motion in dynamic lighting conditions such as nighttime.

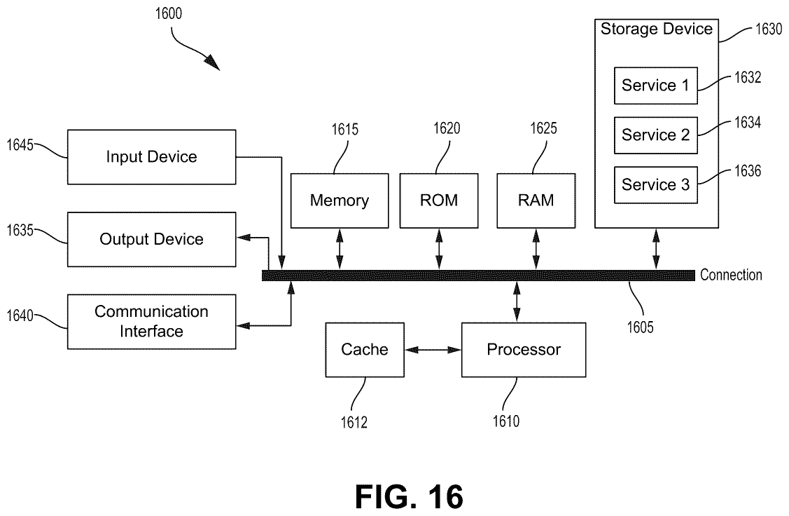

In some examples, the processes described herein (e.g., methods 1000 and 1300, and/or other process described herein) may be performed by a computing device or apparatus. In one example, the methods 1000 and 1300 can be performed by a computing device (e.g., image capture and processing system 200 in FIG. 2) having a computing architecture of the computing system 1600 shown in FIG. 16.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the methods described herein, including the methods 1000 and 1300. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of methods described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The methods 1000 and 1300 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The methods 1000 and 1300, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

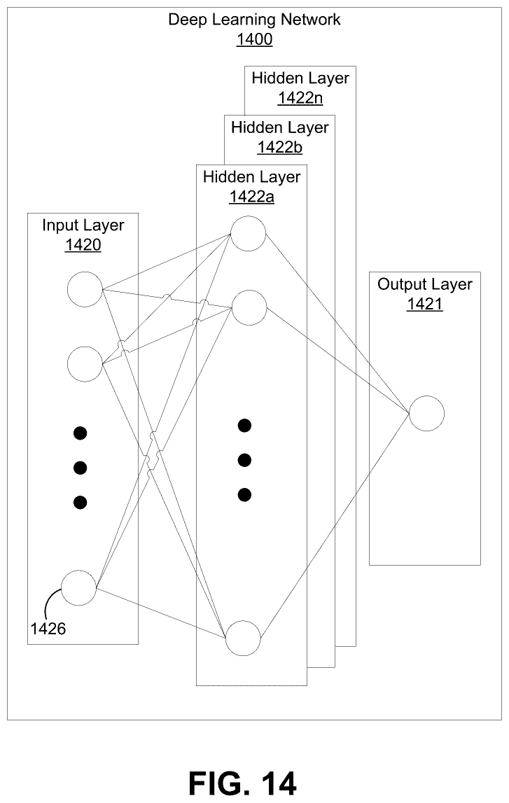

As noted above, various aspects of the present disclosure can use machine learning models or systems. FIG. 14 is an illustrative example of a deep learning neural network 1400 that can be used to implement the machine learning based alignment prediction described above. An input layer 1420 includes input data. In one illustrative example, the input layer 1420 can include data representing the pixels of an input video frame. The neural network 1400 includes multiple hidden layers 1422a, 1422b, through 1422n. The hidden layers 1422a, 1422b, through 1422n include “n” number of hidden layers, where “n” is an integer greater than or equal to one. The number of hidden layers can be made to include as many layers as needed for the given application. The neural network 1400 further includes an output layer 1421 that provides an output resulting from the processing performed by the hidden layers 1422a, 1422b, through 1422n. In one illustrative example, the output layer 1421 can provide a classification for an object in an input video frame. The classification can include a class identifying the type of activity (e.g., looking up, looking down, closing eyes, yawning, etc.).

The neural network 1400 is a multi-layer neural network of interconnected nodes. Each node can represent a piece of information. Information associated with the nodes is shared among the different layers and each layer retains information as information is processed. In some cases, the neural network 1400 can include a feed-forward network, in which case there are no feedback connections where outputs of the network are fed back into itself. In some cases, the neural network 1400 can include a recurrent neural network, which can have loops that allow information to be carried across nodes while reading in input.

Information can be exchanged between nodes through node-to-node interconnections between the various layers. Nodes of the input layer 1420 can activate a set of nodes in the first hidden layer 1422a. For example, as shown, each of the input nodes of the input layer 1420 is connected to each of the nodes of the first hidden layer 1422a. The nodes of the first hidden layer 1422a can transform the information of each input node by applying activation functions to the input node information. The information derived from the transformation can then be passed to and can activate the nodes of the next hidden layer 1422b, which can perform their own designated functions. Example functions include convolutional, up-sampling, data transformation, and/or any other suitable functions. The output of the hidden layer 1422b can then activate nodes of the next hidden layer, and so on. The output of the last hidden layer 1422n can activate one or more nodes of the output layer 1421, at which an output is provided. In some cases, while nodes (e.g., node 1426) in the neural network 1400 are shown as having multiple output lines, a node has a single output and all lines shown as being output from a node represent the same output value.

In some cases, each node or interconnection between nodes can have a weight that is a set of parameters derived from the training of the neural network 1400. Once the neural network 1400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1400 to be adaptive to inputs and able to learn as more and more data is processed.

The neural network 1400 is pre-trained to process the features from the data in the input layer 1420 using the different hidden layers 1422a, 1422b, through 1422n in order to provide the output through the output layer 1421. In an example in which the neural network 1400 is used to identify features and/or objects in images, the neural network 1400 can be trained using training data that includes both images and labels, as described above. For instance, training images can be input into the network, with each training frame having a label indicating the features in the images (for a feature extraction machine learning system) or a label indicating classes of an activity in each frame. In one example using object classification for illustrative purposes, a training frame can include an image of a number 2, in which case the label for the image can be [0 0 1 0 0 0 0 0 0 0].

In some cases, the neural network 1400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 1400 is trained well enough so that the weights of the layers are accurately tuned.

For the example of identifying features and/or objects in images, the forward pass can include passing a training image through the neural network 1400. The weights are initially randomized before the neural network 1400 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 1400, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1400 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1400 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

The neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1400 can include any other deep network other than a CNN, such as an autoencoder, a deep belief nets (DBNs), a Recurrent Neural Networks (RNNs), among others.

FIG. 15 is an illustrative example of a CNN 1500. The input layer 1520 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1522a, an optional non-linear activation layer, a pooling hidden layer 1522b, and fully connected hidden layers 1522c to get an output at the output layer 1524. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 is the convolutional hidden layer 1522a. The convolutional hidden layer 1522a analyzes the image data of the input layer 1520. Each node of the convolutional hidden layer 1522a is connected to a region of nodes (pixels) of the input image called a receptive field. The convolutional hidden layer 1522a can be considered as one or more filters (each filter corresponding to a different activation or feature map), with each convolutional iteration of a filter being a node or neuron of the convolutional hidden layer 1522a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1522a. Each connection between a node and a receptive field for that node learns a weight and, in some cases, an overall bias such that each node learns to analyze its particular local receptive field in the input image. Each node of the hidden layer 1522a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1522a is due to each node of the convolutional layer being applied to its corresponding receptive field. For example, a filter of the convolutional hidden layer 1522a can begin in the top-left corner of the input image array and can convolve around the input image. As noted above, each convolutional iteration of the filter can be considered a node or neuron of the convolutional hidden layer 1522a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1522a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1522a.

The mapping from the input layer to the convolutional hidden layer 1522a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1522a can include several activation maps in order to identify multiple features in an image. The example shown in FIG. 15 includes three activation maps. Using three activation maps, the convolutional hidden layer 1522a can detect three different kinds of features, with each feature being detectable across the entire image.

In some examples, a non-linear hidden layer can be applied after the convolutional hidden layer 1522a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1500 without affecting the receptive fields of the convolutional hidden layer 1522a.

The pooling hidden layer 1522b can be applied after the convolutional hidden layer 1522a (and after the non-linear hidden layer when used). The pooling hidden layer 1522b is used to simplify the information in the output from the convolutional hidden layer 1522a. For example, the pooling hidden layer 1522b can take each activation map output from the convolutional hidden layer 1522a and generates a condensed activation map (or feature map) using a pooling function. Max-pooling is one example of a function performed by a pooling hidden layer. Other forms of pooling functions be used by the pooling hidden layer 1522a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1522a. In the example shown in FIG. 15, three pooling filters are used for the three activation maps in the convolutional hidden layer 1522a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1522a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1522a having a dimension of 24×24 nodes, the output from the pooling hidden layer 1522b will be an array of 18×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1522b to every one of the output nodes in the output layer 1524. Using the example above, the input layer includes 28×28 nodes encoding the pixel intensities of the input image, the convolutional hidden layer 1522a includes 3×24×24 hidden feature nodes based on application of a 5×5 local receptive field (for the filters) to three activation maps, and the pooling hidden layer 1522b includes a layer of 3×12×12 hidden feature nodes based on application of max-pooling filter to 2×2 regions across each of the three feature maps. Extending this example, the output layer 1524 can include ten output nodes. In such an example, every node of the 3×12×12 pooling hidden layer 1522b is connected to every node of the output layer 1524.

The fully connected layer 1522c can obtain the output of the previous pooling hidden layer 1522b (which should represent the activation maps of high-level features) and determines the features that most correlate to a particular class. For example, the fully connected layer 1522c layer can determine the high-level features that most strongly correlate to a particular class, and can include weights (nodes) for the high-level features. A product can be computed between the weights of the fully connected layer 1522c and the pooling hidden layer 1522b to obtain probabilities for the different classes. For example, if the CNN 1500 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1524 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 is a diagram illustrating an example of a system for implementing certain aspects of the present technology. In particular, FIG. 16 illustrates an example of computing system 1600, which can be for example any computing device making up internal computing system, a remote computing system, a camera, or any component thereof in which the components of the system are in communication with each other using connection 1605. Connection 1605 can be a physical connection using a bus, or a direct connection into processor 1610, such as in a chipset architecture. Connection 1605 can also be a virtual connection, networked connection, or logical connection.

In some aspects, computing system 1600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1600 includes at least one processing unit (CPU or processor) 1610 and connection 1605 that couples various system components including system memory 1615, such as ROM 1620 and RAM 1625 to processor 1610. Computing system 1600 can include a cache 1612 of high-speed memory connected directly with, in close proximity to, or integrated as part of processor 1610.

Processor 1610 can include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms. In some instances, multimodal systems can enable a user to provide multiple types of input/output to communicate with computing system 1600. Computing system 1600 can include communications interface 1640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1630 can include software services, servers, services, etc., that when the code that defines such software is executed by the processor 1610, it causes the system to perform a function. In some aspects, a hardware service that performs a particular function can include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

In some examples, the processes described herein (e.g., methods 1000 and 1300, and/or other process described herein) may be performed by a computing device or apparatus. In one example, the methods 1000 and 1300 can be performed by a computing device (e.g., image capture and processing system 200 in FIG. 2) having a computing architecture of the computing system 1600 shown in FIG. 16.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the methods described herein, including the methods 1000 and 1300. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of methods described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The methods 1000 and 1300 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The methods 1000 and 1300, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

As noted above, various aspects of the present disclosure can use machine learning models or systems. FIG. 14 is an illustrative example of a deep learning neural network 1400 that can be used to implement the machine learning based alignment prediction described above. An input layer 1420 includes input data. In one illustrative example, the input layer 1420 can include data representing the pixels of an input video frame. The neural network 1400 includes multiple hidden layers 1422a, 1422b, through 1422n. The hidden layers 1422a, 1422b, through 1422n include “n” number of hidden layers, where “n” is an integer greater than or equal to one. The number of hidden layers can be made to include as many layers as needed for the given application. The neural network 1400 further includes an output layer 1421 that provides an output resulting from the processing performed by the hidden layers 1422a, 1422b, through 1422n. In one illustrative example, the output layer 1421 can provide a classification for an object in an input video frame. The classification can include a class identifying the type of activity (e.g., looking up, looking down, closing eyes, yawning, etc.).

The neural network 1400 is a multi-layer neural network of interconnected nodes. Each node can represent a piece of information. Information associated with the nodes is shared among the different layers and each layer retains information as information is processed. In some cases, the neural network 1400 can include a feed-forward network, in which case there are no feedback connections where outputs of the network are fed back into itself. In some cases, the neural network 1400 can include a recurrent neural network, which can have loops that allow information to be carried across nodes while reading in input.

Information can be exchanged between nodes through node-to-node interconnections between the various layers. Nodes of the input layer 1420 can activate a set of nodes in the first hidden layer 1422a. For example, as shown, each of the input nodes of the input layer 1420 is connected to each of the nodes of the first hidden layer 1422a. The nodes of the first hidden layer 1422a can transform the information of each input node by applying activation functions to the input node information. The information derived from the transformation can then be passed to and can activate the nodes of the next hidden layer 1422b, which can perform their own designated functions. Example functions include convolutional, up-sampling, data transformation, and/or any other suitable functions. The output of the hidden layer 1422b can then activate nodes of the next hidden layer, and so on. The output of the last hidden layer 1422n can activate one or more nodes of the output layer 1421, at which an output is provided. In some cases, while nodes (e.g., node 1426) in the neural network 1400 are shown as having multiple output lines, a node has a single output and all lines shown as being output from a node represent the same output value.

In some cases, each node or interconnection between nodes can have a weight that is a set of parameters derived from the training of the neural network 1400. Once the neural network 1400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1400 to be adaptive to inputs and able to learn as more and more data is processed.

The neural network 1400 is pre-trained to process the features from the data in the input layer 1420 using the different hidden layers 1422a, 1422b, through 1422n in order to provide the output through the output layer 1421. In an example in which the neural network 1400 is used to identify features and/or objects in images, the neural network 1400 can be trained using training data that includes both images and labels, as described above. For instance, training images can be input into the network, with each training frame having a label indicating the features in the images (for a feature extraction machine learning system) or a label indicating classes of an activity in each frame. In one example using object classification for illustrative purposes, a training frame can include an image of a number 2, in which case the label for the image can be [0 0 1 0 0 0 0 0 0 0].

In some cases, the neural network 1400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 1400 is trained well enough so that the weights of the layers are accurately tuned.

For the example of identifying features and/or objects in images, the forward pass can include passing a training image through the neural network 1400. The weights are initially randomized before the neural network 1400 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 1400, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1400 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1400 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1400 can include any other deep network other than a CNN, such as an autoencoder, a deep belief nets (DBNs), a Recurrent Neural Networks (RNNs), among others.

FIG. 15 is an illustrative example of a CNN 1500. The input layer 1520 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1522a, an optional non-linear activation layer, a pooling hidden layer 1522b, and fully connected hidden layers 1522c to get an output at the output layer 1524. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 is the convolutional hidden layer 1522a. The convolutional hidden layer 1522a analyzes the image data of the input layer 1520. Each node of the convolutional hidden layer 1522a is connected to a region of nodes (pixels) of the input image called a receptive field. The convolutional hidden layer 1522a can be considered as one or more filters (each filter corresponding to a different activation or feature map), with each convolutional iteration of a filter being a node or neuron of the convolutional hidden layer 1522a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1522a. Each connection between a node and a receptive field for that node learns a weight and, in some cases, an overall bias such that each node learns to analyze its particular local receptive field in the input image. Each node of the hidden layer 1522a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1522a is due to each node of the convolutional layer being applied to its corresponding receptive field. For example, a filter of the convolutional hidden layer 1522a can begin in the top-left corner of the input image array and can convolve around the input image. As noted above, each convolutional iteration of the filter can be considered a node or neuron of the convolutional hidden layer 1522a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1522a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1522a.

The mapping from the input layer to the convolutional hidden layer 1522a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1522a can include several activation maps in order to identify multiple features in an image. The example shown in FIG. 15 includes three activation maps. Using three activation maps, the convolutional hidden layer 1522a can detect three different kinds of features, with each feature being detectable across the entire image.

In some examples, a non-linear hidden layer can be applied after the convolutional hidden layer 1522a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1500 without affecting the receptive fields of the convolutional hidden layer 1522a.

The pooling hidden layer 1522b can be applied after the convolutional hidden layer 1522a (and after the non-linear hidden layer when used). The pooling hidden layer 1522b is used to simplify the information in the output from the convolutional hidden layer 1522a. For example, the pooling hidden layer 1522b can take each activation map output from the convolutional hidden layer 1522a and generates a condensed activation map (or feature map) using a pooling function. Max-pooling is one example of a function performed by a pooling hidden layer. Other forms of pooling functions be used by the pooling hidden layer 1522a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1522a. In the example shown in FIG. 15, three pooling filters are used for the three activation maps in the convolutional hidden layer 1522a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1522a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1522a having a dimension of 24×24 nodes, the output from the pooling hidden layer 1522b will be an array of 18×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1522b to every one of the output nodes in the output layer 1524. Using the example above, the input layer includes 28×28 nodes encoding the pixel intensities of the input image, the convolutional hidden layer 1522a includes 3×24×24 hidden feature nodes based on application of a 5×5 local receptive field (for the filters) to three activation maps, and the pooling hidden layer 1522b includes a layer of 3×12×12 hidden feature nodes based on application of max-pooling filter to 2×2 regions across each of the three feature maps. Extending this example, the output layer 1524 can include ten output nodes. In such an example, every node of the 3×12×12 pooling hidden layer 1522b is connected to every node of the output layer 1524.

The fully connected layer 1522c can obtain the output of the previous pooling hidden layer 1522b (which should represent the activation maps of high-level features) and determines the features that most correlate to a particular class. For example, the fully connected layer 1522c layer can determine the high-level features that most strongly correlate to a particular class, and can include weights (nodes) for the high-level features. A product can be computed between the weights of the fully connected layer 1522c and the pooling hidden layer 1522b to obtain probabilities for the different classes. For example, if the CNN 1500 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1524 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 is a diagram illustrating an example of a system for implementing certain aspects of the present technology. In particular, FIG. 16 illustrates an example of computing system 1600, which can be for example any computing device making up internal computing system, a remote computing system, a camera, or any component thereof in which the components of the system are in communication with each other using connection 1605. Connection 1605 can be a physical connection using a bus, or a direct connection into processor 1610, such as in a chipset architecture. Connection 1605 can also be a virtual connection, networked connection, or logical connection.

In some aspects, computing system 1600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1600 includes at least one processing unit (CPU or processor) 1610 and connection 1605 that couples various system components including system memory 1615, such as ROM 1620 and RAM 1625 to processor 1610. Computing system 1600 can include a cache 1612 of high-speed memory connected directly with, in close proximity to, or integrated as part of processor 1610.

Processor 1610 can include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms. In some instances, multimodal systems can enable a user to provide multiple types of input/output to communicate with computing system 1600. Computing system 1600 can include communications interface 1640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1630 can include software services, servers, services, etc., that when the code that defines such software is executed by the processor 1610, it causes the system to perform a function. In some aspects, a hardware service that performs a particular function can include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### Illustrative Aspects of the Present Disclosure Include:

Aspect 1: A method of processing image data, comprising: obtaining, at a computing device, a first image of an object at a first position in an environment; obtaining, at the computing device, a second image of the object at a second position in the environment; and determining, at the computing device, movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, and brightness variations.

Aspect 2: The method of Aspect 1, wherein a part of the object is illuminated in the first image and a different part of the object is illuminated in the second image.

Aspect 3:. The method of any of Aspects 1 to 2, further comprising: generating the augmented training data using the noise associated with the low ambient lighting conditions; and training the optical flow engine based on the augmented training data.

Aspect 4: The method of any of Aspects 1 to 3, wherein generating the augmented training data using the noise associated with the low ambient lighting conditions comprises: applying first noise to a training image pair based on the low ambient lighting conditions; and applying second noise to the training image pair based on thermal conditions.

Aspect 5: The method of any of Aspects 1 to 4, wherein the first noise comprises a photon shot noise associated with the low ambient lighting conditions and the second noise comprises thermal readout noise associated with the image sensor.

Aspect 6: The method of any of Aspects 1 to 5, wherein the noise associated with the low ambient lighting conditions corresponds to I(x)=N(μ=x, σ²=ax+b), where I is an image, x is a pixel of the image, μ a mean value, σ is a variation, N is a normal distribution, and a and b are variables that correspond to one of the first noise or the second noise.

Aspect 7: The method of any of Aspects 1 to 6, further comprising: generating the augmented training data using the noise associated with the motion blur; and training the optical flow engine based on the augmented training data.

Aspect 8: The method of any of Aspects 1 to 7, wherein generating the augmented training data using the noise associated with the motion blur comprises: applying at least one motion blur kernel to a training image pair based on at least one parameter.

Aspect 9: The method of any of Aspects 1 to 8, wherein the at least one parameter is associated with a point spread function (PSF) to emulate motion blur.

Aspect 10: The method of any of Aspects 1 to 9, wherein the at least one parameter comprises at least one of a motion blur kernel size, an intensity, a linear direction, or a non-linear direction.

Aspect 11: The method of any of Aspects 1 to 10, further comprising: generating the augmented training data using the brightness variations; and training the optical flow engine based on the augmented training data.

Aspect 12: The method of any of Aspects 1 to 11, wherein generating the augmented training data using the brightness variations comprises: obtaining a mask; modifying a brightness of regions in a training image based on the mask to generate a modified training image; inputting the training image and the modified training image into a neural network; determine a first loss associated with the training image and an output of the neural network based on processing the training image; determine a second loss associated with the modified training image input and an output of the neural network based on processing the modified training image; and training the neural network based on the first loss and the second loss.

Aspect 13: The method of any of Aspects 1 to 12, further comprising: summing the first loss and the second loss to generate a total loss, wherein the neural network is trained based on the total loss.

Aspect 14: The method of any of Aspects 1 to 13, wherein training the neural network desensitizes the neural network to variations in brightness between the first image and the second image.

Aspect 15: The method of any of Aspects 1 to 14, wherein the optical flow engine comprises a Recurrent All-Pairs Field Transforms (RAFT) neural network.

Aspect 16: The method of any of Aspects 1 to 15, further comprising: determining at least one of a direction and a velocity of the object based on an output from the optical flow engine, wherein the direction and velocity comprises one of a float value or a vector value.

Aspect 17: The method of any of Aspects 1 to 16, wherein the second position is different from the first position.

Aspect 18: The method of any of Aspects 1 to 17, wherein the computing system moves between the first image and the second image.

Aspect 19: An apparatus for processing image data includes at least one memory (e.g., implemented in circuitry) and at least one processor coupled to the at least one memory. The at least one processor is configured to: obtain, at a computing device, a first image of an object at a first position in an environment; obtain, at the computing device, a second image of the object at a second position in the environment; and determine, at the computing device, movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, and brightness variations.

Aspect 20: The apparatus of Aspect 19, wherein a part of the object is illuminated in the first image and a different part of the object is illuminated in the second image.

Aspect 21: The apparatus of any of Aspects 19 to 20, wherein the at least one processor is configured to: generate the augmented training data using the noise associated with the low ambient lighting conditions; and train the optical flow engine based on the augmented training data.

Aspect 22: The apparatus of any of Aspects 19 to 21, wherein the at least one processor is configured to: apply first noise to a training image pair based on the low ambient lighting conditions; and apply second noise to the training image pair based on thermal conditions.

Aspect 23: The apparatus of any of Aspects 19 to 22, wherein the first noise comprises a photon shot noise associated with the low ambient lighting conditions and the second noise comprises thermal readout noise associated with the image sensor.

Aspect 24: The apparatus of any of Aspects 19 to 23, wherein the noise associated with the low ambient lighting conditions corresponds to I(x)=N(μ=x, ρ²=ax+b), where I is an image, x is a pixel of the image, μ a mean value, ρ is a variation, N is a normal distribution, and a and b are variables that correspond to one of the first noise or the second noise.

Aspect 25: The apparatus of any of Aspects 19 to 24, wherein the at least one processor is configured to: generate the augmented training data using the noise associated with the motion blur; and train the optical flow engine based on the augmented training data.

Aspect 26: The apparatus of any of Aspects 19 to 25, wherein the at least one processor is configured to: apply at least one motion blur kernel to a training image pair based on at least one parameter.

Aspect 27: The apparatus of any of Aspects 19 to 26, wherein the at least one parameter is associated with a point spread function (PSF) to emulate motion blur.

Aspect 28: The apparatus of any of Aspects 19 to 27, wherein the at least one parameter comprises at least one of a motion blur kernel size, an intensity, a linear direction, or a non-linear direction.

Aspect 29: The apparatus of any of Aspects 19 to 28, wherein the at least one processor is configured to: generate the augmented training data using the brightness variations; and train the optical flow engine based on the augmented training data.

Aspect 30: The apparatus of any of Aspects 19 to 29, wherein the at least one processor is configured to: obtain a mask; modify a brightness of regions in a training image based on the mask to generate a modified training image; input the training image and the modified training image into a neural network; determine a first loss associated with the training image and an output of the neural network based on processing the training image; determine a second loss associated with the modified training image input and an output of the neural network based on processing the modified training image; and train the neural network based on the first loss and the second loss.

Aspect 31: The apparatus of any of Aspects 19 to 30, wherein the at least one processor is configured to: sum the first loss and the second loss to generate a total loss, wherein the neural network is trained based on the total loss.

Aspect 32: The apparatus of any of Aspects 19 to 31, wherein training the neural network desensitizes the neural network to variations in brightness between the first image and the second image.

Aspect 33: The apparatus of any of Aspects 19 to 32, wherein the optical flow engine comprises a Recurrent All-Pairs Field Transforms (RAFT) neural network.

Aspect 34: The apparatus of any of Aspects 19 to 33, wherein the at least one processor is configured to: determine at least one of a direction and a velocity of the object based on an output from the optical flow engine, wherein the direction and velocity comprises one of a float value or a vector value.

Aspect 35: The apparatus of any of Aspects 19 to 34, wherein the second position is different from the first position.

Aspect 36: The apparatus of any of Aspects 19 to 35, wherein the apparatus is configured to move between the first image and the second image.

Aspect 37: A non-transitory computer-readable medium comprising instructions which, when executed by one or more processors, cause the one or more processors to perform operations according to any of Aspects 1 to 18.

Aspect 38: An apparatus comprising means for performing operations according to any of Aspects 1 to 18.

What is claimed is:

1. An apparatus for processing image data, comprising:
at least one memory; and
at least one processor coupled to the at least one memory and configured to:
obtain a first image of an object at a first position in an environment;
obtain a second image of the object at a second position in the environment; and
determine movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, or brightness variations.

2. The apparatus of claim 1, wherein a part of the object is illuminated in the first image and a different part of the object is illuminated in the second image.

3. The apparatus of claim 1, wherein the at least one processor is configured to:
generate the augmented training data using the noise associated with the low ambient lighting conditions; and
train the optical flow engine based on the augmented training data.

4. The apparatus of claim 3, wherein, to generate the augmented training data using the noise associated with the low ambient lighting conditions, the at least one processor is configured to:
apply first noise to a training image pair based on the low ambient lighting conditions; and
apply second noise to the training image pair based on thermal conditions.

5. The apparatus of claim 4, wherein the first noise comprises a photon shot noise associated with the low ambient lighting conditions and the second noise comprises thermal readout noise associated with the image sensor.

6. The apparatus of claim 3, wherein the at least one processor is configured to:
generate the augmented training data using the noise associated with the motion blur; and
train the optical flow engine based on the augmented training data.

7. The apparatus of claim 6, wherein, to generate the augmented training data using the noise associated with the motion blur, the at least one processor is configured to:
apply at least one motion blur kernel to a training image pair based on at least one parameter.

8. The apparatus of claim 7, wherein the at least one parameter is associated with a point spread function (PSF) to emulate motion blur.

9. The apparatus of claim 8, wherein the at least one parameter comprises at least one of a motion blur kernel size, an intensity, a linear direction, or a non-linear direction.

10. The apparatus of claim 3, wherein the at least one processor is configured to:
generate the augmented training data using the brightness variations; and
train the optical flow engine based on the augmented training data.

11. The apparatus of claim 10, wherein, to generate the augmented training data using the brightness variations, the at least one processor is configured to:
obtain a mask;
modify a brightness of regions in a training image based on the mask to generate a modified training image;
input the training image and the modified training image into a neural network;
determine a first loss associated with the training image and an output of the neural network based on processing the training image;
determine a second loss associated with the modified training image input and an output of the neural network based on processing the modified training image; and
train the neural network based on the first loss and the second loss.

12. The apparatus of claim 11, wherein the at least one processor is configured to:
sum the first loss and the second loss to generate a total loss, wherein the neural network is trained based on the total loss.

13. The apparatus of claim 1, wherein the optical flow engine comprises a Recurrent All-Pairs Field Transforms (RAFT) neural network.

14. The apparatus of claim 1, wherein the at least one processor is configured to:
determine at least one of a direction or a velocity of the object based on an output from the optical flow engine, wherein the direction and velocity comprises one of a float value or a vector value.

15. The apparatus of claim 1, wherein the second position is different from the first position.

16. The apparatus of claim 1, wherein the first image corresponds to a first position of the apparatus and the second image corresponds to a second position of the apparatus.

17. A method of processing image data, comprising:
obtaining, at a computing device, a first image of an object at a first position in an environment;
obtaining, at the computing device, a second image of the object at a second position in the environment; and
determining, at the computing device, movement of the object in the first image and the second image at least in part using an optical flow engine, wherein the optical flow engine is trained based on augmented training data generated using at least one of noise associated with low ambient lighting conditions, noise associated with motion blur due to exposure of an image sensor in low ambient lighting conditions, or brightness variations.

18. The method of claim 17, wherein a part of the object is illuminated in the first image and a different part of the object is illuminated in the second image.

19. The method of claim 17, further comprising:
generating the augmented training data using the noise associated with the low ambient lighting conditions; and
training the optical flow engine based on the augmented training data.

20. The method of claim 19, further comprising:
applying first noise to a training image pair based on the low ambient lighting conditions; and
applying second noise to the training image pair based on thermal conditions.

21. The method of claim 20, wherein the first noise comprises a photon shot noise associated with the low ambient lighting conditions and the second noise comprises thermal readout noise associated with the image sensor.

22. The method of claim 19, further comprising:
generating the augmented training data using the noise associated with the motion blur; and
training the optical flow engine based on the augmented training data.

23. The method of claim 22, further comprising:
applying at least one motion blur kernel to a training image pair based on at least one parameter.

24. The method of claim 23, wherein the at least one parameter is associated with a point spread function (PSF) to emulate motion blur.

25. The method of claim 24, wherein the at least one parameter comprises at least one of a motion blur kernel size, an intensity, a linear direction, or a non-linear direction.

26. The method of claim 19, further comprising:
generating the augmented training data using the brightness variations; and
training the optical flow engine based on the augmented training data.

27. The method of claim 26, further comprising:
obtaining a mask;
modifying a brightness of regions in a training image based on the mask to generate a modified training image;
inputting the training image and the modified training image into a neural network;
determining a first loss associated with the training image and an output of the neural network based on processing the training image;
determining a second loss associated with the modified training image input and an output of the neural network based on processing the modified training image; and
training the neural network based on the first loss and the second loss.

28. The method of claim 27, further comprising:
summing the first loss and the second loss to generate a total loss, wherein the neural network is trained based on the total loss.

29. The method of claim 17, further comprising:
determining at least one of a direction or a velocity of the object based on an output from the optical flow engine, wherein the direction and velocity comprises one of a float value or a vector value.

30. The method of claim 17, wherein the second position is different from the first position.
